(19) United States
(12) Patent Application Publication
(10) Pub. No.: US 2020/0164596 A1
(43) Pub. Date: May 28, 2020

(54) AN APPARATUS AND METHOD FOR MANUFACTURING A SOLAR COLLECTOR

(71) Applicant: Green Energy Investment Group LLC, Lewes, DE (US)

(72) Inventor: Shawn Brook WILLIAMSON, Lyford, TX (US)

(21) Appl. No.: 16/631,970

(22) PCT Filed: Jul. 19, 2018
(86) PCT No.: PCT/ZA2018/050040

§ 371 Date: Jan. 17, 2020

Related U.S. Application Data
(60) Provisional application No. 62/534,491, filed on Jul. 19, 2017.

(51) Int. Cl. B29C 65/20; F24S 10/70; F24S 80/30

(52) U.S. Cl. CPC B29C 65/2015; F24S 80/30; F24S 10/70

(57) ABSTRACT

The apparatus 10 includes a table 12 which defines a flat top surface 14. Two spaced apart, parallel tracks 16.1, 16.2 are mounted on top of the surface 14. A first positioning arrangement 18, is displaceably mounted on top of the tracks 16. When in use, a plurality 5 of collector tubes 300 can be arranged parallel to one another on top of the frame 24 such that they extend along a displacement path 400 of the tracks 16 and are substantially perpendicular to tubes 306 and 308.

### BACKGROUND OF THE INVENTION

This invention relates to an apparatus for manufacturing a solar collector and a solar geyser, as well as to a method of manufacturing the same.

During the manufacture of solar collectors, by means of fusion welding, each of the solar collector tubes are typically fusion welded one by one to a larger cylindrical tube. This process can be quite time-consuming when a large number of solar collector tubes need to be fusion welded to the larger cylindrical tube.

The Inventor wishes to address this problem.

### SUMMARY OF THE INVENTION

According to the invention, there is provided an apparatus for manufacturing a solar collector, wherein the apparatus includes:
a first positioning arrangement which is configured to position an elongate first tube of a solar collector, in which first tube a row of spaced apart holes is defined along a length of the tube;
a second positioning arrangement which is configured to position a plurality of elongate solar collector tubes to extend, in a spaced apart, parallel fashion relative to each other, in line with and away from the row of holes defined in the first tube; and
a first heating arrangement which includes at least one heating member which is configured to heat respective first ends of the collector tubes which face the first tube, and parts of the first tube in which the holes are defined, simultaneously, when in use.

The apparatus may include a first displacement arrangement which is configured to allow the first ends of the collector tubes, once heated, to be moved/displaced into the respective holes of the first tube, in order to allow the heated first ends to fusion weld with the respective heated parts of the first tube in which the holes are defined. In this regard, it will be appreciated that the holes defined in the first tube are typically shaped and dimensioned in order to allow the first ends of the collector tubes to fit snugly therein.

The second positioning arrangement may be configured to position the collector tubes in an orientation in which they extend substantially perpendicular to a longitudinal axis (and therefore to the row of holes) of the first tube.

The first and/or second positioning arrangement(s) may be configured to align the respective first ends of the collector tubes with corresponding holes in the first tube, when in use, such that each first end is in register with a corresponding hole in the first tube. Therefore, in use, each collector tube is aligned with one of the holes provided in the first tube. The term “tube-hole pairing” hereinafter refers to the pairing of one of the holes in the first tube and a corresponding collector tube which is aligned therewith.

The first heating arrangement may include a heating element for each tube-hole pairing, in order to heat the tube-hole pairings simultaneously, when in use. The first heating arrangement may therefore include a plurality of heating elements. Each heating element may include a first heating part which is configured to heat the first end of a particular collector tube, and a second heating part which is configured to heat part of the first tube in which the holes are defined which corresponds to the said collector tube (i.e. which together forms a tube-hole pairing). The first heating part may be a first end of the heating element, while the second heating part may be an opposite second end of the heating element. The second heating part may be configured to fit into the corresponding hole of the first tube, preferably in a snug manner, in order to heat the part of the first tube in which a particular hole is defined. The first heating part may define a socket for receiving the first end of the corresponding collector tube, when in use, in order to heat the end of the collector tube.

The first heating arrangement may include a first alignment arrangement which is configured to displace the heating elements for the tube-hole pairings relative to the first and second positioning arrangements between an inoperative operative position in which the heating elements are not aligned/in register with the holes provided in the first tube and/or the corresponding first ends of the collector tubes (i.e. not aligned with the tube-hole pairings), and an operative position in which the heating elements are aligned/in register with the holes provided in the first tube and/or the corresponding first ends of the collector tubes (i.e. aligned with the tube-hole pairings).

In the operative position, each of the heating elements is located in-between the corresponding hole and the first end of its corresponding collector tube. When in the operative position, the first heating part may be aligned with the first end of the corresponding collector tube, while the second heating part may be aligned with the corresponding hole. The first displacement arrangement may be configured to displace the first and/or second positioning arrangement(s) relative to the heating elements such that, when the heating elements are in their operative position, the first ends of the collector tubes and/or the holes of the first tube are brought into contact with the first and second heating parts of the heating elements, respectively, when in use.

More specifically, the apparatus may include a second displacement arrangement, wherein
the first displacement arrangement is configured to displace the collector tubes relative to the heating elements, when the heating elements are positioned in their operative position, between a first position in which the first ends of the collector tubes are spaced from the first parts of the heating elements, and a second position in which the first ends of the collector tubes contact/engage with the first parts of the heating elements; and
the second displacement arrangement may be configured to displace the first tube relative to the heating elements, when the heating elements are positioned in their operative position, between a first position in which the holes are spaced from the second parts of the heating elements, and a second position in which the second parts of the heating elements extend into the holes.

The first displacement arrangement may be configured to displace the second positioning arrangement relative to the first positioning arrangement in a direction which is transverse to the longitudinal axis of the first tube, when in use. The direction may, more specifically, be perpendicular to the longitudinal axis (and therefore the row of holes) of the first tube. The first displacement arrangement may therefore be configured to displace the second positioning arrangement towards the first positioning arrangement in order to allow the first ends of the collector tubes to be displaced into the respective holes defined in the first tube, when in use.

The apparatus may further include:
a third positioning arrangement which is spaced from the first positioning arrangement and which is configured to position an elongate second tube of a solar collector, in which second tube a row of spaced apart holes is defined along a length of the tube; and
a second heating arrangement which includes at least one heating member which is configured to heat respective second ends of the collector tubes which face the second tube, and parts of the second tube in which the holes are defined simultaneously, when in use.

The second heating arrangement may include any one or more of the features of the first heating arrangement, as described above, but in relation to the second tube and collector tube. The second heating arrangement may therefore be similar to the first heating arrangement.

The second and/or third positioning arrangement(s) may be configured to align the respective second ends of the collector tubes with the respective holes in the second tube, when in use, such that each second end is in register with a corresponding hole in the second tube. Therefore, in use, each collector tube is aligned with one of the holes provided in the second tube. The term “second tube-hole pairing” hereinafter refers to the pairing of one of the holes in the second tube and a corresponding collector tube which is aligned therewith.

The second heating arrangement may include a second heating element for each second tube-hole pairing, in order to heat the second tube-hole pairings simultaneously, when in use. The second heating arrangement may therefore include a plurality of second heating elements. The second heating elements may include a first heating part which is configured to heat the second end of a particular collector tube, and a second heating part which is configured to heat part of the second tube which defines one of the holes of the second tube which corresponds to the said collector tube (i.e. which together forms a second tube-hole pairing). The first heating part of the second heating element may be a first end of the second heating element, while the second heating part of the second heating element may be an opposite end of the second heating element. The second heating part of the second heating element may be configured to fit into the corresponding hole of the second tube, preferably in a snug manner, in order to heat the part of the second tube in which the particular hole is defined. The first heating part of the second heating element may define a socket for receiving the second end of the corresponding collector tube, when in use, in order to heat the second end of the collector tube.

The second heating arrangement may include a second alignment arrangement which is configured to displace the second heating elements for the second tube-hole pairings relative to the second and third positioning arrangements between an inoperative position in which the second heating elements are not aligned/in register with the holes provided in the second tube and/or the corresponding second ends of the collector tubes (i.e. not aligned with the second tube-hole pairings), when in use, and an operative position in which the second heating elements are aligned with the holes provided in the second tube and/or the corresponding second end of the collector tubes (i.e. aligned with the second tube-hole pairings).

When the second heating elements are in their operative positions, each of the second heating elements is located in-between the hole provided in the second tube and the second end of its corresponding collector tube. When in the operative position, the second heating parts of the second heating elements may be aligned with the corresponding holes, while the first heating parts may be aligned with the second ends of the corresponding collector tubes, when in use. The second displacement arrangement may be configured to displace the second and/or third positioning arrangement(s) relative to the second heating elements such that, when the second heating elements are in their operative position, the holes in the second tube and/or second ends of the collector tubes are brought into contact with the first/second heating parts of the second heating elements, when in use.
According to a second aspect of the invention, there is provided a method of manufacturing a solar collector by using an elongate first tube in which first tube a row of spaced apart holes is defined along a length of the tube, and a plurality of elongate solar collector tubes, wherein the method includes at least the steps of:
heating respective first ends of the collector tubes and respective parts of the first tube in which the holes are defined simultaneously, by using a first heating arrangement; and
moving the first ends of the collector tubes, once heated, into the respective holes of the first tube, in order to allow the heated first ends to fusion weld with the respective parts of the first tube in which the holes are defined.

The step of heating respective first ends of the collector tubes and the respective parts of the first tube in which the holes are defined may more specifically include:
bringing each hole of the first tube and the corresponding first end of the collector tube into engagement with a heating element of the first heating arrangement, in order to heat the first ends of the collector tubes and respective parts of the first tube in which the holes are defined.

The step of bringing each hole of the first tube and the corresponding first end of the collector tube into engagement with a heating element may include using a plurality of heating elements, one for each collector tube and its corresponding hole in the first tube. The term “tube-hole pairing” hereinafter refers to the pairing of one of the holes in the first tube and a corresponding collector tube. One heating element may therefore be used for each tube-hole pairing.

The heating elements may each include a first heating end and an opposite second heating end. The method may include, for each tube-hole pairing, bringing the collector tube into engagement with the first heating end and part of the first tube which define the corresponding hole into engagement with the second heating end. The engagement of the collector tubes with the first heating ends may be implemented simultaneously (i.e. at the same time). The engagement of the collector tubes with the parts of the first tube in which the corresponding holes are defined may be implemented simultaneously (i.e. at the same time).

### BRIEF DESCRIPTION OF THE DRAWINGS

The invention will now be described, by way of a non-limiting example, with reference to the accompanying diagrammatic drawings.

In the drawings:

FIG. 1 shows a three-dimensional view of an apparatus for manufacturing a solar collector, in accordance with the invention;

FIG. 2 shows a front view of the apparatus of FIG. 1;

FIG. 3 shows a side view of the apparatus of FIG. 1;

FIG. 4 shows a top view of the apparatus of FIG. 1;

FIG. 5 shows a sectional side view of a heating element of a first/second heating arrangement of the apparatus;

FIG. 6 shows a sectional side view of the heating element of FIG. 5, when used to heat two parts of a solar collector which are to be fusion welded together; and

FIG. 7 shows a three-dimensional exploded view of a solar collector, together with a plurality of heating elements shown in FIG. 5.

### DESCRIPTION OF PREFERRED EMBODIMENTS

In the drawings, reference numeral 10 refers generally to an apparatus for manufacturing a solar collector 100 in accordance with the invention, which can be used in a solar geyser or other solar heating arrangement.

The apparatus 10 includes a table 12 which defines a flat top surface 14. Two spaced apart, parallel tracks 16.1, 16.2 (hereinafter collectively referred to as “16”) are mounted on top of the surface 14. A first positioning arrangement 18, is displaceably mounted on top of the tracks 16.

The first positioning arrangement includes a rectangular mounting frame 24, four support legs which extend operatively downwardly from the frame 24 and four support rollers 26 which are located at respective lower/bottom ends of the support legs. The rollers 26 are located on top of the tracks 16 in order to allow the frame 24 to be displaced along the length of the tracks 16.

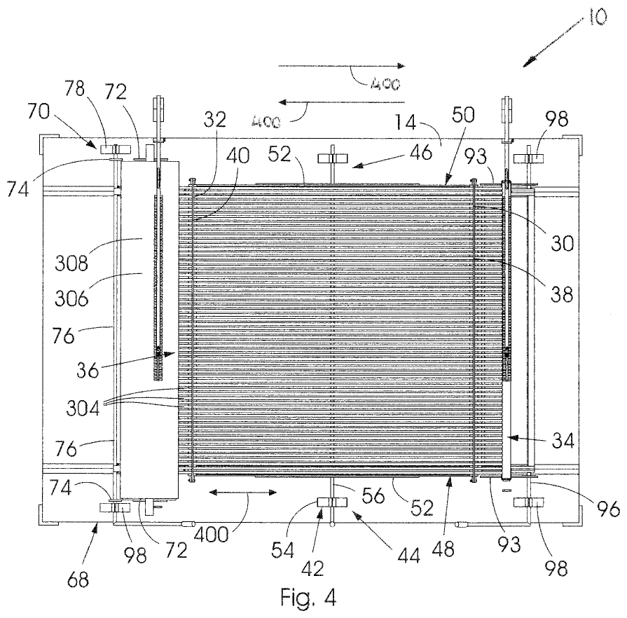

When in use, a plurality of collector tubes 300 can be arranged/oriented parallel to one another on top of the frame 24 such that they extend along a displacement path 400 of the tracks 16. The collector tubes 300 are secured on top of the frame 24 by means of two securing arrangements 30, 32 which are located towards opposed ends 34, 36 of the collector tubes 300 (see FIG. 4). Each securing arrangement 30, 32 includes an elongate securing/clamping members 38, 40 which is oriented perpendicular to a longitudinal direction of the collector tubes 300 and which extends across the plurality of solar collector tubes 300, in order to secure them to the frame 24. More specifically, each the securing member 38, 40 defines a plurality of holes through which the collector tubes 300 can extend. These holes are arranged such that collector tubes 300 are equally spaced from one another and extend parallel to the displacement path 400.

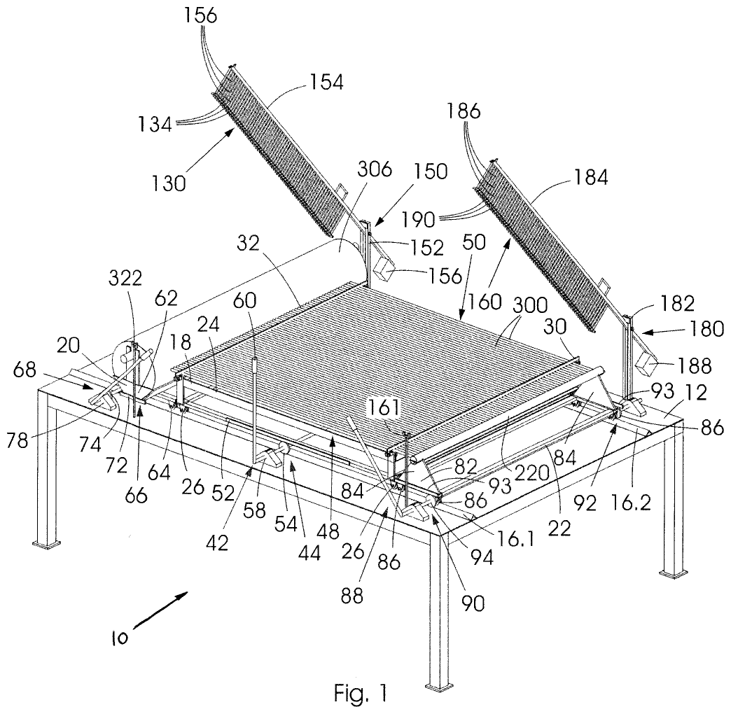

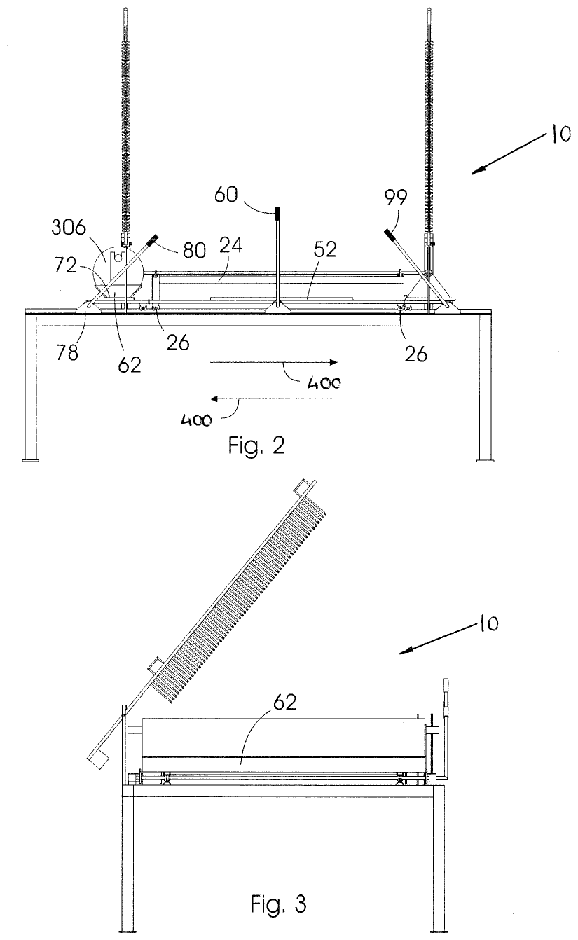

The apparatus 10 includes a first displacement arrangement 42 which is configured to facilitate displacement of the first positioning arrangement 18 along the tracks 16 (see FIG. 1). The first displacement arrangement 42 includes two rack-and-pinion mechanisms 44, 46 which are located on opposed sides 48, 50 of the frame 24. Each rack-and-pinion mechanism 44, 46 includes an elongate, toothed/approved bar 52 which is secured to the frame 24 and extends along the length of the respective tracks 16. Each rack-and-pinion mechanism 44, 46 also includes a gear/cog 54.

The gears 54 are interconnected via a central shaft 56. The shaft 56 is rotatably mounted on either side to the table 12 via a mounting structure/block 58, such that the shaft 56 is rotatable about an axis of rotation which is orientated perpendicular to the path 400. Rotation of the shaft 56 therefore causes rotation of the gears 54 about the axis of rotation of the shaft 56. Each gear 54 operatively engages its corresponding bar 52 such that when the gears 54 rotate, they displace the frame 12 along the tracks 16 as a result of the rotational movement of the gears 54 being transferred into a linear motion of the bar 52. A lever 60 extends operatively upwardly from one end of the shaft 56 in order to rotate the gears 54, so that the frame 24 can be displaced along the tracks 16. The level 60 is typically operated manually.

A second positioning arrangement 20 is displaceably mounted on top of the tracks 16. The second positioning arrangement 20 includes an elongate support formation/bracket 62 which extends across the tracks 16 and which is configured to allow a large cylindrical tube/storage tank 306 (hereinafter referred to as the first tube 306) of a solar collector 100 to be mounted therein such that the first tube 306, extends across the ends 36 of the collector tubes 300 (i.e. transverse to the tracks 16), when the solar collector is being manufactured. In other words, respective first ends 36 of the collector tubes 300 will face a radially outer side 308 of the first tube 306.

The support bracket 62 includes four support rollers 64 which are located on top of the tracks 16 in order to allow the support bracket 62 to be displaced along the length of the tracks 16. The apparatus 10 includes a second displacement arrangement 66 which is configured to facilitate displacement of the second positioning arrangement 20 along the tracks 16. The second displacement arrangement 66 also includes two rack-and-pinion mechanisms 68, 70 which are located on opposed ends of the bracket 62. These rack-and-pinion mechanisms 68, 70 are typically configured in a similar manner to the rack-and-pinion mechanisms 44, 46.

More specifically, the rack-and-pinion mechanisms 68, 70 includes an elongate, toothed/approved bar 72 which is mounted/secured to a bottom part of one end of the bracket 20 and extends along the length of the respective tracks 16. Each rack-and-pinion mechanism 68, 70 also includes a gear/cog 74. The gears 74 are interconnected via a central shaft 76. The shaft 76 is rotatably mounted on either side to the table 12 via a mounting structure/block 78, such that the shaft 76 is rotatable about an axis of rotation which is orientated perpendicular to the direction 400. Rotation of the shaft 76 therefore causes rotation of the gears 74 about the axis of rotation of the shaft 76.

Each gear 74 operatively engages its corresponding bar 52 such that when the gears 74 rotate, they displace the bracket 62 along the tracks 16 as a result of the rotational movement of the gears 74 being transferred into a linear motion of the bars 72. A lever 80 extends operatively upwardly from one end of the shaft 76 in order to rotate the gears 74, so that the support bracket 62 can be displaced along the tracks 16. The level 80 is typically operated manually.

A third positioning arrangement 22, is displaceably mounted on top of the tracks 16. The third positioning arrangement 22 includes an elongate support formation/bracket 82 which extends across the tracks 16 and which is configured to allow a second tube 308 of a solar collector 100 to be mounted thereon such that the second tube 308 extends across the ends 34 of the collector tubes 300 (i.e. transverse to the tracks), when a solar collector is being manufactured. In other words, respective second ends 34 (opposite the first ends 36) of the collector tubes 300 will face a radially outer side 220 of the second tube 308.

The support bracket 82 includes two generally triangular shaped support formations 84 which are located on top of the tracks 16.1, 16.2, respectively, and which are configured to support respective ends of the second tube 308. More specifically, each support formation 84 is mounted on top of its corresponding track 16 via two support rollers 86 which run on top of the tracks 16, in order to allow the support bracket 84 to be displaced along the length of the tracks 16. The apparatus 10 includes a third displacement arrangement 88 which is configured to facilitate displacement of the third positioning arrangement 22 along the tracks 16. The third displacement arrangement 88 also includes two rack-and-pinion mechanisms 90, 92 which are located on the respective support formations 84. These rack-and-pinion mechanisms 90, 92 are typically configured in a similar manner to the rack-and-pinion mechanisms 44, 46.

More specifically, the rack-and-pinion mechanisms 90, 92 each include an elongate, toothed/grooved bar 93 which is mounted/secured to its corresponding support formation 84 and extends along the length of the respective tracks 16. Each rack-and-pinion mechanism 90, 92 also includes a gear/cog 94. The gears 94 are interconnected via a central shaft 96. The shaft 96 is rotatably mounted on either side to the table 12 via a mounting structure/block 98, such that the shaft 96 is rotatable about an axis of rotation which is orientated perpendicular to the direction 400. Rotation of the shaft 96 therefore causes rotation of the gears 94 about the axis of rotation of the shaft 96.

Each gear 94 operatively engages its corresponding bar 93 such that when the gears 94 rotate, they displace the bracket 82 along the tracks 16 as a result of the rotational movement of the gears 94 being transferred into a linear motion of the bars 93. A lever 99 extends operatively upwardly from one end of the shaft 96 in order to rotate the gears 94, so that the support bracket 82 can be displaced along the tracks 16.

The apparatus 10 further includes a first heating arrangement 130 which is mounted to the table 12 via a first alignment arrangement 150. The first alignment arrangement 150 includes an upright, elongate mounting structure 152 which is secured to, and projects upwardly from the table 12. More specifically, the mounting structure 152 is located on the side 50 of the frame 24, approximate the ends 36 of the collector tubes 300, when secured to the frame 24. In other words, the mounting structure 152 is located proximate a meeting point/area between the frame 24 and bracket 62.

An elongate bar/member 154 is pivotally mounted to a top portion of the mounting structure 152 about an axis which is generally parallel to the track direction 400. The member 154 is orientated to extend generally perpendicular to the track direction 400, when seen in top view, and is configured to pivot between an inoperative upper position as shown in FIG. 1 and an operative lower position which will be described in more detail below. A counterweight 156 is secured to the member 154 in order to help ease the displacement of the member 154 between its two positions.

The plurality of rods/elongate members 156 are spaced along the length of the member 154 and project perpendicularly downwardly therefrom in a parallel fashion.

The first heating arrangement 130 includes a plurality of heating elements/studs 134 which are each mounted to lower, free ends of the rods 156, respectively. In other words, a heating element 134 is secured to the lower free ends of each of the rods 156. Although not specifically shown, an elongate heating plate/bar will typically be mounted to extend between all of the heating elements 134 in order to heat the heating elements 134.

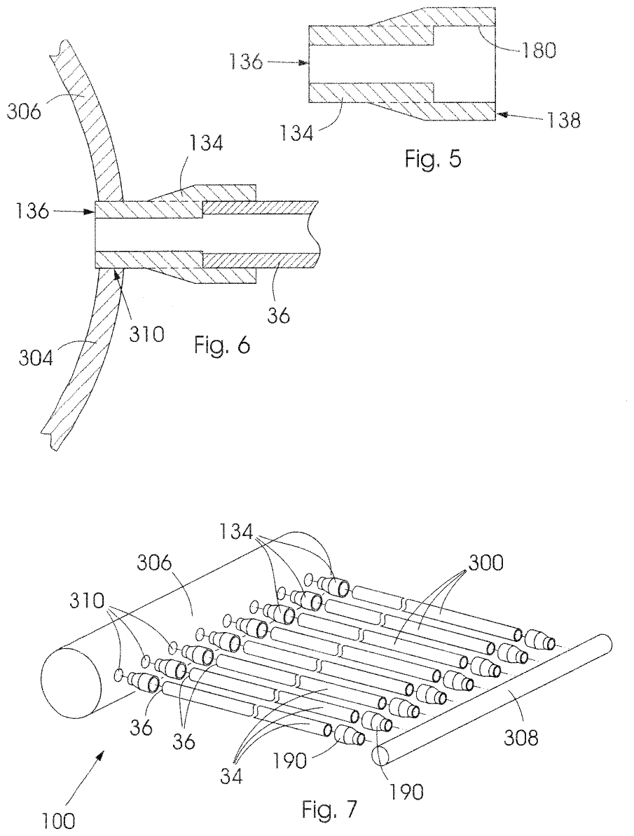

FIG. 5 illustrates one of these heating elements 134 in more detail. Each of the heating elements 134 typically has a first end 136 and an opposite, second end 138. The first end 136 typically has a rounded cylindrical shape which is dimensioned to fit in a hole 310 which is provided in the radially outer side 308 of the first tube 306. The opposite end 138 defines a cylindrical socket/cavity 140 which is dimensioned in order to receive one of the ends 36 of the collector tubes 300 in a snuggly/tight fit manner. Reference is in this regard specifically made to FIG. 6.

During the manufacturing of a solar collector 100, a plurality of holes 310 are typically drilled into the radially outer side 308 of the first tube 306. The holes 310 are spaced along the length of the tube 306 and the spacing between the holes 310 is the same as the spacing between the collector tubes 300, as well as the spacing between the heating elements 134. When the first tube 306 is mounted in the support formation 62 and the collector tubes are secured to the frame 24 (as shown in FIG. 1), then the holes 310 in the first tube 306 are aligned/in register with the collector tubes 300 (more specifically the ends 36 of the collector tubes 300), respectively.

When the member 154 is in its operative lower position, then a free end 320 of the member 154 typically rests on an upright support 322. When the member 154 is in this operative lower position, and the first part 306 and collector tubes 300 are positioned on respective sides of the member 154, the ends 136 are aligned/in register with the holes 310 of the first tube 306, while the cavities 140 are aligned with the ends 36 of the collector tubes 300 (see FIG. 7).

The apparatus 10 further includes a second heating arrangement 160, which is substantially identical to the first heating arrangement 130, and which is mounted to the table 12 via a second alignment arrangement 180 which is substantially identical to the first alignment arrangement 150. The second alignment arrangement 180 therefore also includes an upright, elongate mounting structure 182 which is secured to, and projects upwardly from the table 12. More specifically, the mounting structure 182 is located on the side 50 of the frame 24 (when seen in side view), approximate the ends 34 of the collector tubes 300, when secured to the frame 24. In other words, the mounting structure 182 is located proximate a meeting point/area between the frame 24 and bracket 84.

An elongate bar/member 184 is pivotally mounted to a top portion of the mounting structure 182 about an axis which is generally parallel to the path 400. A plurality of rods/elongate members 186 are spaced along the length of the member 184 and project perpendicularly downwardly therefrom in a parallel fashion. A counterweight 188 is also provided on the member 184.

The second heating arrangement 160 includes a plurality of heating elements/studs 190 which are each mounted to lower, free ends of the rods 186, respectively. Although not specifically shown, an elongate heating plate/bar will typically be mounted to extend between all of the heating elements 190 in order to heat the heating elements 190.

During the manufacturing of a solar collector, a plurality of holes is typically also drilled into a radially outer side 220 of the second tube 308. The holes are spaced along the length of the second tube 308 and the spacing between the holes is the same as the spacing between the collector tubes 300, as well as the spacing between the heating elements 190. When the second tube 308 is mounted in the brackets 82, 84 and the collector tubes 300 are secured to the frame 24 (as shown in FIG. 1), then the holes in the second tube 308 are aligned/in register with the collector tubes 300 (more specifically the ends 34 of the collector tubes 300), respectively.

When the member 184 is in its operative lower position, then a free end of the member 184 typically rests on an upright support 161. When the member 184 is in this operative lower position, and the second tube 308 and collector tubes 300 are positioned on respective sides of the member 184, the ends 136 are aligned/in register with the holes of the first tube 306, while the cavities 140 are aligned with the ends 34 of the collector tubes 300. The collector tubes and/or tubes 306, 308 are typically made of a polymer(s) or another type of material which can melt at a high temperature, in order to facilitate fusion welding.

In order to begin the manufacturing of a solar collector 100, the holes 310 are typically drilled into the first tube 306 (at equally spaced position). The same is also done with the tube 308. These tubes 306, 308 are then positioned in the respective positioning arrangements 20, 22. The individual collector tubes 300 are secured to the frame 24 by using the two securing members 30, 32. When the tubes 300, 306, 308 are secured in this manner, then each of the holes provided in the tubes 306, 308 are aligned/in register with one of the collector tubes 300.

The actual fusion/attachment of the collector tubes 300 to the tubes 306, 308 will now be described in more detail.

By using the levers 60, 80 and 99, the positioning arrangements 18, 20, 22 are displaced along the tracks 16 such that alignment arrangements 150, 180 can be used to displace the members 154, 184 into the lower operative positions in which each heating element 134, 190 is aligned/in register with one of the holes provided in one of the tubes 306, 308 on the one side, and with one solar collector tubes 300 and the other side.

The handle 60 can then be used to displace the collector tube ends 36 into the individual cavities 140 in order to engage the ends 36 with the heating elements 134. In a similar manner, the lever 80 can then be used in order to displace the first tube 306 towards the heating elements so that the ends 36 of the heating elements 134 extend into the holes 310 and contacts/engages with various parts/portions of the first tube 306 which define the holes 310. The elongate heating plate/bar can then be used to heat the individual heating elements 134, 190 which, in turn, heats the ends 36 and the part of the first tube 306 which define the holes 310.

Once the ends 36 and the parts of the first tube 306 have been sufficiently heated, the handles 80, 60 can then again be used to disengage the first tube 306 and collector tubes 300 from the heating elements and the member 154 is raised into its inoperative position so that it no longer forms a barrier between the holes 310 and collector tubes 300. The handles 60, 80 are then used in order to insert the ends 36 into the holes 310. Due to the contact between the heated ends 36 and the heated parts of the first tube 306 which define the holes (i.e. due to the tight fit connection), all the collector tubes 300 fusion weld with the first tube 300.

The second tube 308 can be fusion welded to the ends 34 in a similar manner by using the levers 60, 99, the second alignment arrangement 180 and second heating arrangement 160.

The inventor believes that the apparatus in accordance with the invention provides an effective way of fusion welding all the collector tubes 300 to a particular larger tube 306, 308 at the same time, which helps save manufacturing time (i.e. thereby increasing productivity), as well as the cost of manufacturing.

It is to be appreciated, that the invention is not limited to any specific embodiment or configuration hereinbefore described and/or illustrated.

1-29. (canceled)

30. An apparatus for manufacturing a solar collector, the apparatus including:
a first positioning arrangement which is configured to position an elongate first tube of a solar collector, in which first tube a row of spaced apart holes is defined along a length of the tube;
a second positioning arrangement which is configured to position a plurality of elongate solar collector tubes to extend, in a spaced apart, parallel fashion, relative to each other in line with and away from the row of holes defined in the first tube; and
a first heating arrangement which includes at least one heating member which is configured to heat respective first ends of the collector tubes which face the first tube, and parts of the first tube in which the holes are defined, simultaneously, when in use.

31. The apparatus of claim 30, wherein the apparatus includes a first displacement arrangement which is configured to allow the first ends of the collector tubes, once heated, to be displaced into the respective holes of the first tube, in order to allow the heated first ends to fusion weld with the respective heated parts of the first tube in which the holes are defined.

32. The apparatus of claim 31, wherein the second positioning arrangement is configured to position the collector tubes in an orientation in which they extend substantially perpendicular to a longitudinal axis of the first tube.

33. The apparatus of claim 32, wherein the first and/or second positioning arrangement(s) are configured to align the respective first ends of the collector tubes with corresponding holes in the first tube, when in use, such that each first end is in register with a corresponding hole in the first tube.

34. The apparatus of claim 33, wherein the first heating arrangement includes a heating element for each collector tube and associated hole (a tube-hole pairing), in order to heat the tube-hole pairings simultaneously, when in use.

35. The apparatus of claim 34, wherein the first heating arrangement includes a plurality of heating elements, each heating element including a first heating part which is configured to heat the first end of a particular collector tube, and a second heating part which is configured to heat part of the first tube in which the holes are defined which correspond to the said collector tube.

36. The apparatus of claim 35, wherein the first heating part is a first end of the heating element, while the second heating part is an opposite second end of the heating element and wherein the second heating part is configured to fit into the corresponding hole of the first tube in order to heat the part of the first tube in which a particular hole is defined and the first heating part defines a socket for receiving the first end of the corresponding collector tube, when in use, in order to heat the end of the collector tube.

37. The apparatus of claim 36, wherein the first heating arrangement includes a first alignment arrangement which is configured to displace the heating elements for the tube-hole pairings relative to the first and second positioning arrangements between an inoperative operative position in which the heating elements are not aligned with the holes provided in the first tube and/or the corresponding first ends of the collector tubes and an operative position in which the heating elements are aligned with the holes provided in the first tube and/or the corresponding first ends of the collector tubes.

38. The apparatus of claim 37, wherein the first displacement arrangement is configured to displace the first and/or second positioning arrangements relative to the heating elements such that, when the heating elements are in their operative position, the first ends of the collector tubes and/or the holes of the first tube are brought into contact with the first and second heating parts of the heating elements, respectively, when in use.

39. The apparatus of claim 38, wherein the apparatus includes a second displacement arrangement, wherein
the first displacement arrangement is configured to displace the collector tubes relative to the heating elements, when the heating elements are positioned in their operative position, between a first position in which the first ends of the collector tubes are spaced from the first parts of the heating elements, and a second position in which the first ends of the collector tubes contact/engage with the first parts of the heating elements; and wherein
the second displacement arrangement may be configured to displace the first tube relative to the heating elements, when the heating elements are positioned in their operative position, between a first position in which the holes are spaced from the second parts of the heating elements, and a second position in which the second parts of the heating elements extend into the holes.

40. The apparatus of claim 39, wherein the first displacement arrangement is configured to displace the second positioning arrangement relative to the first positioning arrangement in a direction which is transverse to the longitudinal axis of the first tube, when in use so as to displace the second positioning arrangement towards the first positioning arrangement in order to allow the first ends of the collector tubes to be displaced into the respective holes defined in the first tube, when in use.

41. The apparatus of claim 40, wherein the apparatus includes:
a third positioning arrangement which is spaced from the first positioning arrangement and which is configured to position an elongate second tube of a solar collector, in which second tube a row of spaced apart holes is defined along a length of the tube; and
a second heating arrangement which includes at least one heating member which is configured to heat respective second ends of the collector tubes which face the second tube, and parts of the second tube in which the holes are defined simultaneously, when in use.

42. The apparatus of claim 41, wherein the second heating arrangement includes the features of the first heating arrangement, in relation to the second tube and collector tube.

43. The apparatus of claim 42, wherein the second and/or third positioning arrangement(s) are configured to align the respective second ends of the collector tubes with the respective holes in the second tube, when in use, such that each second end is in register with a corresponding hole in the second tube.

44. The apparatus of claim 43, wherein the second heating arrangement includes a second heating element for each second tube-hole pairing, in order to heat the second tube-hole pairings simultaneously, when in use.

45. The apparatus of claim 44, wherein the second heating arrangement includes a plurality of second heating elements which each include a first heating part which is configured to heat the second end of a particular collector tube, and a second heating part which is configured to heat part of the second tube which defines one of the holes of the second tube which corresponds to the said collector tube.

46. The apparatus of claim 45, wherein the first heating part of the second heating element is a first end of the second heating element, while the second heating part of the second heating element is an opposite end of the second heating element; and wherein the second heating part of the second heating element is configured to fit into the corresponding hole of the second tube in order to heat the part of the second tube in which the particular hole is defined and the first heating part of the second heating element defines a socket for receiving the second end of the corresponding collector tube, when in use, in order to heat the second end of the collector tube.

47. The apparatus of claim 46, wherein the second heating arrangement includes a second alignment arrangement which is configured to displace the second heating elements for the second tube-hole pairings relative to the second and third positioning arrangements between an inoperative position in which the second heating elements are not aligned with the holes provided in the second tube and/or the corresponding second ends of the collector tubes when in use, and an operative position in which the second heating elements are aligned with the holes provided in the second tube and/or the corresponding second end of the collector tubes.

48. The apparatus of claim 39, wherein the second displacement arrangement is configured to displace the second and/or third positioning arrangement(s) relative to the second heating elements such that, when the second heating elements are in their operative position, the holes in the second tube and/or second ends of the collector tubes are brought into contact with the first/second heating parts of the second heating elements, when in use.

49. A method of manufacturing a solar collector by using an elongate first tube in which first tube a row of spaced apart holes is defined along a length of the tube, and a plurality of elongate solar collector tubes, the method including at least the following steps:
heating respective first ends of the collector tubes and respective parts of the first tube in which the holes are defined simultaneously, by using a first heating arrangement; and
moving the first ends of the collector tubes, once heated, into the respective holes of the first tube, in order to allow the heated first ends to fusion weld with the respective parts of the first tube in which the holes are defined.

50. A method of claim 49, wherein the step of heating respective first ends of the collector tubes and the respective parts of the first tube in which the holes are defined include the step of:
bringing each hole of the first tube and the corresponding first end of the collector tube into engagement with a heating element of the first heating arrangement, in order to heat the first ends of the collector tubes and respective parts of the first tube in which the holes are defined.

51. The method of claim 50, wherein the step of bringing each hole of the first tube and the corresponding first end of the collector tube into engagement with a heating element includes using a plurality of heating elements, one for each collector tube and its corresponding hole in the first tube.

52. The method of claim 51, wherein the heating elements each include a first heating end and an opposite second heating end.

53. The method of claim 52, wherein the method includes the step of bringing the collector tube into engagement with the first heating end and part of the first tube which define the corresponding hole into engagement with the second heating end.
